(19) United States
(12) Patent Application Publication
(10) Pub. No.: US 2026/0063240 A1
(43) Pub. Date: Mar. 5, 2026

(54) MULTI-ORIENTATION DEVICE STAND

(71) Applicant: Lenovo (United States) Inc., Morrisville, NC (US)

(72) Inventor: Madison Smith, Santa Rosa, CA (US)

(21) Appl. No.: 18/821,466

(22) Filed: Aug. 30, 2024

(51) Int. Cl. F16M 11/24; F16M 11/10

(52) U.S. Cl. CPC F16M 11/242; F16M 11/10

(57) ABSTRACT

One embodiment provides a device stand, including: a first set of parallel edges, wherein one edge of the first set of parallel edges includes a first pivot point, wherein a portion of the one of the first set of parallel edges below the first pivot point is moveable outward with respect to a front side of the device stand; and a second set of parallel edges, wherein the second set of parallel edges are perpendicular to the first set of parallel edges and wherein the second edge of the first set of parallel edges connects a bottom of both edges of the second set of parallel edges; and wherein each edge of the second set of parallel edges includes a pivot point, wherein a lower portion below the pivot point of each of the edges of the second set of parallel edges is moveable outward with respect to the front side of the device stand. Other aspects are claimed and described.

### BACKGROUND

As information handling devices become more lightweight and even easier to transport traditional ergonomic device features have been bypassed or removed. In the name of transportation, this is a positive evolution of technology. However, when utilizing an information handling device, new challenges can arise. Additionally, as newer features are implemented into information handling devices that will in time become standard to each device type, positive ergonomic features will also be considered in ensuring that a device may be utilized in a comfortable manner. For example, how a user may view a display of an information handling device may be heavily weighted.

### BRIEF SUMMARY

In summary, one aspect provides a device stand, including: a first set of parallel edges, wherein one edge of the first set of parallel edges includes a first pivot point, wherein a portion of the one of the first set of parallel edges below the first pivot point is moveable outward with respect to a front side of the device stand; and a second set of parallel edges, wherein the second set of parallel edges are perpendicular to the first set of parallel edges and wherein the second edge of the first set of parallel edges connects a bottom of both edges of the second set of parallel edges; and wherein each edge of the second set of parallel edges includes a pivot point, wherein a lower portion below the pivot point of each of the edges of the second set of parallel edges is moveable outward with respect to the front side of the device stand.

Another aspect provides a system, including: an information handling device; a device stand, wherein a front side of the device stand is attachable to a back side of the information handling device, the device stand including: a first set of parallel edges, wherein one edge of the first set of parallel edges includes a first pivot point, wherein a portion of the one of the first set of parallel edges below the first pivot point is moveable outward with respect to the front side of the device stand; and a second set of parallel edges, wherein the second set of parallel edges are perpendicular to the first set of parallel edges and wherein the second edge of the first set of parallel edges connects a bottom of both edges of the second set of parallel edges; and wherein each edge of the second set of parallel edges includes a pivot point, wherein a lower portion below the pivot point of each of the edges of the second set of parallel edges is moveable outward with respect to the front side of the device stand.

A further aspect provides a device stand, including: a first set of parallel edges, wherein one edge of the first set of parallel edges includes a first hinge, wherein a portion of the one of the first set of parallel edges below the first hinge is moveable outward with respect to a front side of the device stand, wherein the first set of parallel edges corresponds to a landscape orientation of the system; and a second set of parallel edges, wherein the second set of parallel edges are perpendicular to the first set of parallel edges and wherein the second edge of the first set of parallel edges connects a bottom of both edges of the second set of parallel edges, wherein the second set of parallel edges corresponds to a portrait orientation of the system; wherein each edge of the second set of parallel edges includes a hinge, wherein a lower portion below the hinge of each of the edges of the second set of parallel edges is moveable outward with respect to the front side of the device stand; wherein the device stand is attachable to an information handling device, wherein the front side of the device stand attaches to a back side of the information handling device; and wherein each of the first set of parallel edges and each of the second set of parallel edges are made of a rigid material.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example device stand supporting a device in a landscape orientation.

FIG. 4 illustrates an example device stand supporting a device in a portrait orientation.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

With the removal of components from a traditional information handling device to a more modern device, features that once assisted with device usability have become obsolete. For example, as tablets continue to become more commonplace, features provided by a traditional laptop have been removed, specifically, a clamshell device orientation. A clamshell orientation, or the traditional method of opening and utilizing a laptop, places the display at an angle as compared to the base of the device. The display could be angled by the user for viewing the display of a device when opened. However, devices are providing more features that allow for additional usability. For example, many displays include touch screens which allow a user to provide input to the display directly. Such features may be useful for drawing and handwriting inputs. However, the traditional clamshell orientation of a laptop is not very suitable for such inputs because of the awkward way that a user would have to provide input to the touch display.

Thus, devices are providing more flexibility with respect to how the device can be manipulated. This allows a user with more options regarding how the device might be utilized. For example, instead of a traditional clamshell laptop devices, devices are convertible or foldable allowing the user to utilize the device in a clamshell mode, portrait mode, landscape mode, tablet mode, and/or the like. In other words, modern laptops have an ability to completely open (e.g. reaching a 180 degree angle), thereby allowing the user to utilize the device in the described modes.

The problem is that when the device is completely open, but the user wants to use it in a landscape or portrait mode, the device has no ability to support itself. Conventionally, when using tablet and/or a laptop in a completely opened orientation, a user will have to hold up the device while viewing the display. This will require a user to utilize at least one hand, which negates the hands-free environment. It also prevents the use of external components (e.g., keyboard, mouse, etc.) in combination with the device. Additionally, or alternatively, a user may attempt to prop-up a device against another object, for example, leaning a device up against a book to provide a better viewing angle. This is a nonsecure method of utilizing the device and may result in a device slipping, and/or blocking portions of a display with an item used to do the propping. Therefore, what is needed is a lightweight, durable device stand that can support a device in an upright position.

Accordingly, the described system and method provides a multi-orientation device stand that may be attachable to a device. This device stand may support a device in any orientation. For example, when a user is utilizing a device in a landscape orientation, the device stand may use a single-leg stand (also referred to as a kickstand) that protrudes from the base of the device and holds the device in an upright landscape position. Additionally, or alternatively, when a user is utilizing a device in a portrait orientation, the device stand may use a dual-leg stand or U-shaped stand that protrudes from the base of the device and is supported in an upright position. The multi-orientation device stand includes an amount of resistance that will permit the use of the stand on a variety of devices having a range of weights. In other words, this device stand can support any devices, for example, lightweight tablets, laptop computers, heavier monitors, computer systems, and/or the like.

The device stand is designed to be made from a rigid material, which is a material that is strong and will not give out while supporting an information handling device (e.g., laptop device, tablet device, stand-alone display, set of displays computer system, foldable device, convertible device, etc.). This device stand may include two sets of parallel edges, where the first set of parallel edges are perpendicular to the second set of parallel edges. Thus, the device stand may look similar to a picture frame. However, the frame may not be a complete frame. In other words, the edges within the first set of parallel edges and/or the edges within the second set of parallel edges may not be the same length, thereby creating an opening in the frame.

The device stand may be integral to or attachable to a device and may be located along the bottom of a device and around its perimeter. When not in use as a device stand, the system may act as a foot for the device to keep the device in a single position and/or keep the device from siding along a service. The rigid material of the multi-orientation device stand may include an overmolding to assist with keeping the device stationary and to protect the device stand from becoming damaged and hides the hinge, parting lines, and component features therefore concealing the duality of the stand into one part. Depending on the orientation of the information handling device, a portion of the multi-orientation device stand will protrude out from an indent on the device to support the device. Thus, when the stand is not in use (e.g., the legs of the stand are not protruding in a position to hold the device in an upright position), the stand and bottom of the device will create a planar surface. Further, the device stand may be modular and detachable from the device, the stand may be removed from a device and applied to a separate device. An anchoring or attachment point for the device stand may assist in keeping the device stand secure to an information handling device when connected and when in use.

The illustrated example embodiments will be best understood by reference to the figures. The following description is intended only by way of example, and simply illustrates certain example embodiments.

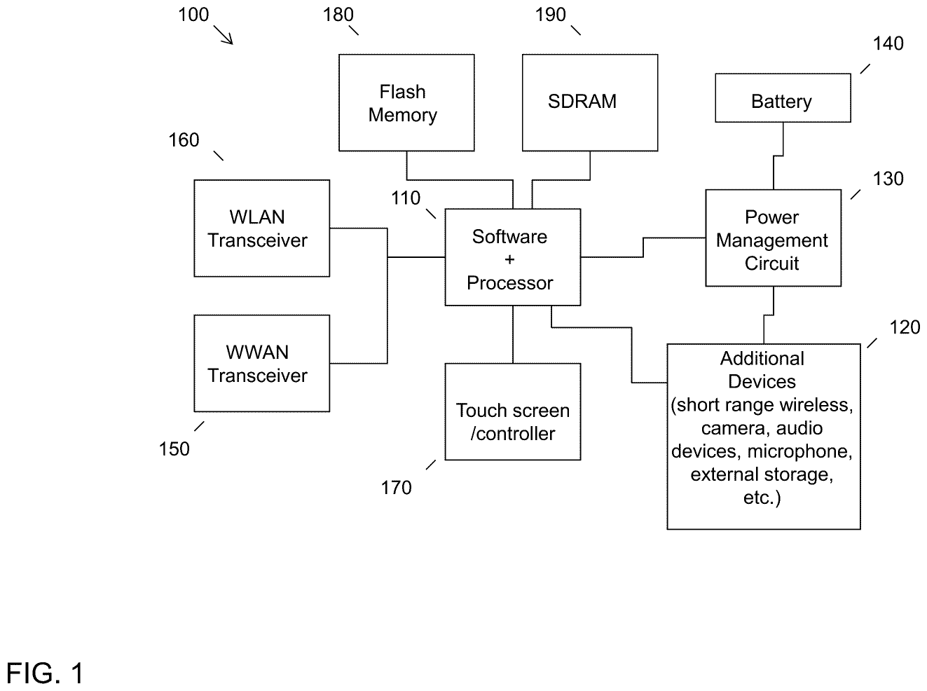

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

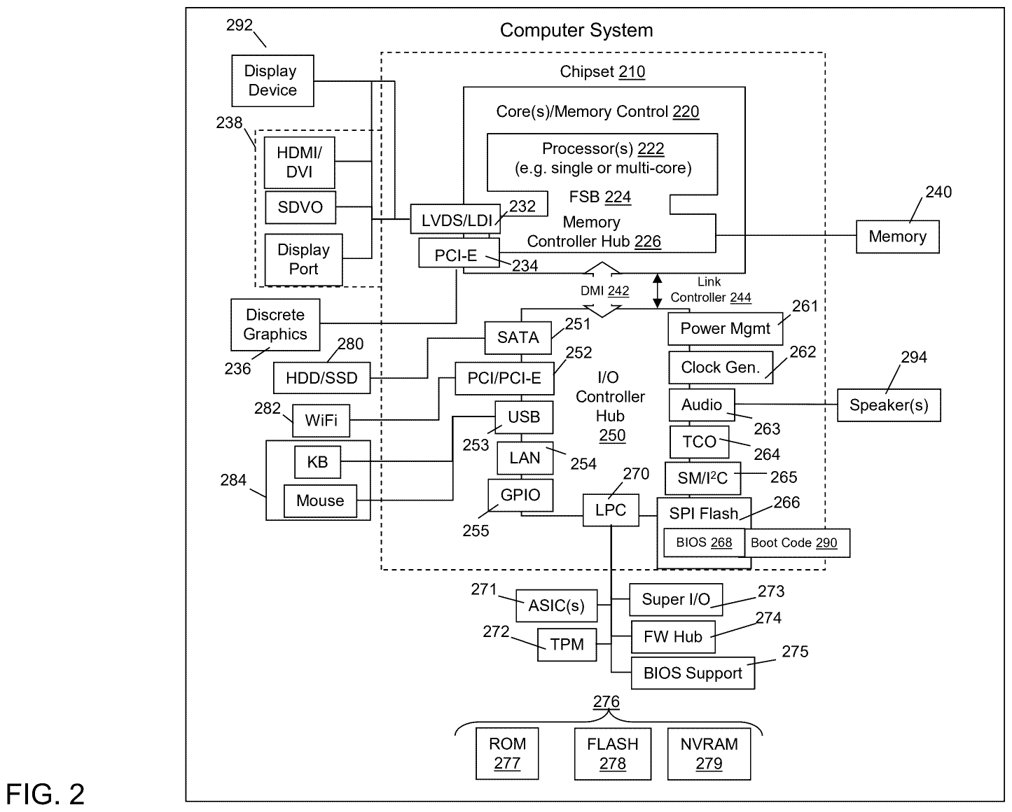

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may used with the adjustable information handling device stand. For example, the circuitry outlined in FIG. 1 may be implemented in a tablet or smart phone embodiment, whereas the circuitry outlined in FIG. 2 may be implemented in a personal computer embodiment.

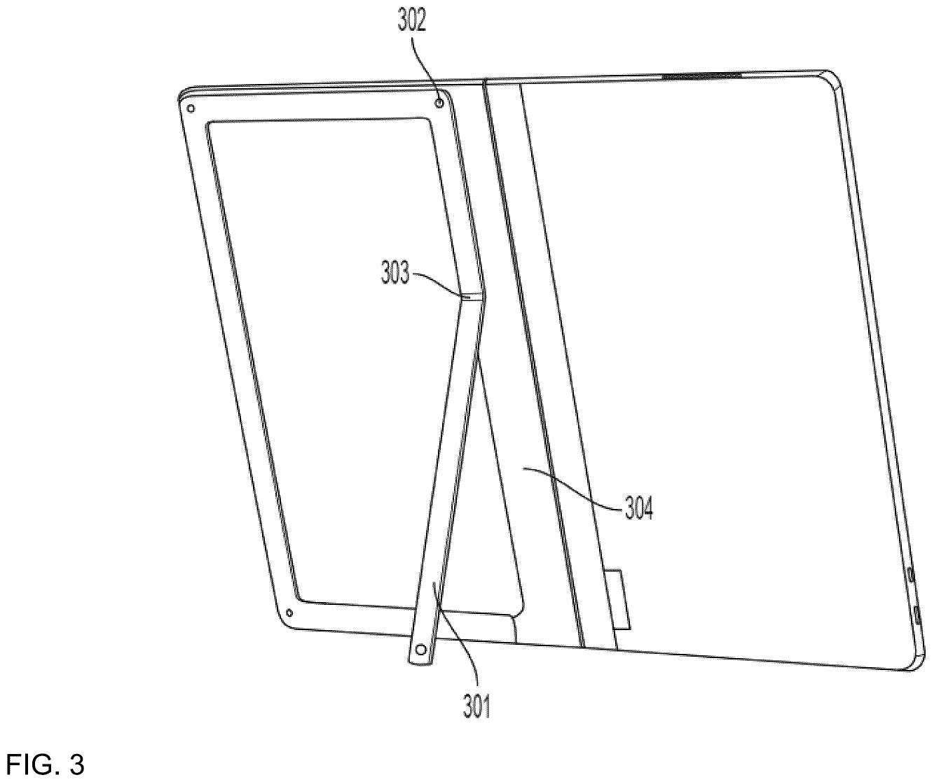

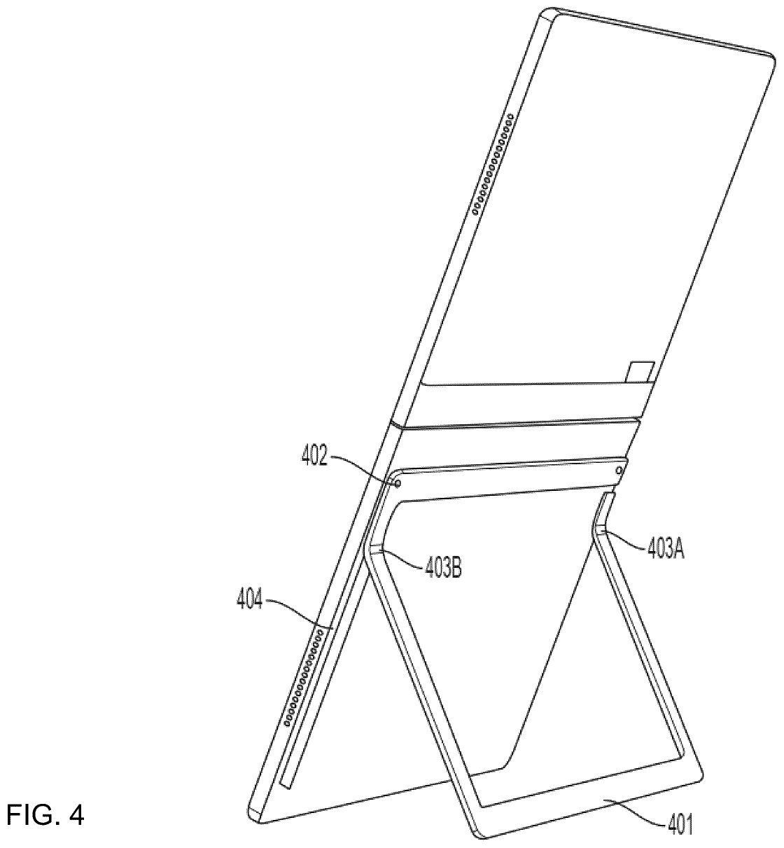

FIG. 3 and FIG. 4 illustrate an example multi-orientation device stand. While the system may include known hardware components and/or hardware components developed in the future, the device itself is specifically designed to provide a light weight yet durable information handling device stand that may successfully support a variety of information handling devices at an orientation aligned with a user display preference. Additionally, the multi-orientation device stand components and features are unique to the described system. The multi-orientation device stand includes a rigid material that may be anchored at a position along the underside of the base of an information handling device. The multi-orientation device stand, further referred to herein as the device stand, may be located around the perimeter of the underside of the base of the information handling device. Throughout the description of the multi-orientation device stand, the information handling device referred to when in use may be a foldable device in a flat configuration (i.e., the display portion and the base portion are planar). However, this is intended as a non-limiting example. The information handling device can be a tablet, a laptop, a smartphone, a smart display, a mobile display with no computing capabilities, a display, a set of displays, and/or the like. The device stand may be orientated to align with user preference while also supporting an information handling device without issues. Additionally, the stand is of a size and design that allows for easy application for a plurality of devices and storage when the device stand is not in use.

The device stand includes a first set of parallel edges and a second set of parallel edges. The second set of parallel edges is perpendicular to the first set of parallel edges. One of the edges of the first set of parallel edges connects to the bottom of each of the edges of the second set of parallel edges, thereby making a frame of sorts. However, the other edge of the first set of parallel edges does not connect to the top of each of the edges of the second set of parallel edges. Rather, the other edge only connects to a top of one of the edges of the second set of parallel edges. The reason for this is to allow for the leg of the edge to be moved outward to support the device. Thus, the length of each of the edges in the first set of parallel edges may not be the same. In other words, one of the edges may be shorter or longer than the other edge. This is also true for the length of the edges in the second set of parallel edges. Thus, the two sets of parallel edges together may not make a complete frame. In other words, there may be an opening in the frame, best illustrated in FIG. 4.

The edges may be made of a rigid material. The rigid material may be a moderately rigid material that still has some flexibility. In other words, the edges may be made of a material that will hold its shape under weight or pressure, but that will still allow some movement of the material, for example, aluminum, plastic, a combination of materials, and/or the like. Alternatively, the edges may be made of a highly rigid material with no flexibility which may also include aluminum, plastic, and/or the like, in addition to steel, carbon fiber, a combination of materials, and/or the like.

The edges may also include a covering or overmolding over the rigid material or core material of the edges. The overmolding may be of any rubberized, rubber-like, or other overmolding material, for example, silicone-based material, polycarbonate, rubber-based material, thermoplastic, nylon, and/or the like. Additionally or alternatively, the overmolding material may be made from a three-dimensional netting material. A material used for the overmolding may be a material that indents friction between the base of the device and a surface, between the base of the device and human skin, and/or the like. Additionally, a material of the overmolding may be durable enough to not kink, crack, split, and/or the like. In other words, since the overmolding may cover the location of the edges that acts as a pivot point, this may be subject to movement and stress. The overmolding must be of a material and thickness to withstand this movement and stress over time. Additionally, the overmolding covering the pivot point needs to move with ease when adjusting an angle of the edge with respect to the device. Thus, the overmolding material that is selected must account for this and must be able to maintain shape and withstand becoming damaged with consistent use.

Additionally, or alternatively, the overmolding material used may assist with providing a durable and supportive device stand. Rather than simply acting as a cover that may also assist with increasing friction levels when a device stand is not being utilized in an upright position, the overmolding may provide additional strength to a stand to keep from the legs of the stand from giving out under potentially heavier devices, and/or may work in combination with the stand maintain a desired angle between the leg of the stand and the information handling device. Thus, the overmolding may provide protection to the rigid material, may cover components of the edges such as the hinges, may provide for slip resistance, and/or the like.

The device stand may be designed to be attachable to a device, for example, a bottom of a base of a device, a back side of a device, and/or any location on the device that a stand would be useful without interfering with the use of the device. Thus, the front side of the device stand may attach to the back side, back surface, or other surface of the device. The front side of the device stand may be arbitrary. In the landscape orientation, the device stand leg may be oriented towards the middle of the device. Thus, the front side of the device stand would be the side of the device stand that would be towards a device while allowing the device stand leg to be in the middle of the device. However, some users may prefer the device stand leg to be towards one side of the device. In this case, the device stand could be oriented to allow for this preference. In this case, the side of the device stand may be the opposite side as compared to the previous example. In this case, the pivot point may allow the device stand leg to pivot in either forward or backward direction so as to allow the desired configuration. Thus, for ease of readability, the front side of the device stand will refer to the side of the device stand opposite to the outward direction that the leg pivots when attached to the device.

In some cases, the device stand may be integral to the device. In this case, the device may include an indent where the device stand fits so that when the device stand is not in use, the device stand and the bottom of the device form a planar surface. Alternatively, the device stand may protrude slightly from the bottom surface of the device, thereby providing a foot for the device. With the overmolding, the foot may prevent the device from slipping across a surface. Alternatively, the device stand may be detachable from the device. In this case, a device may still include the indent for the device stand. However, the device may not include the indent and the device stand may simply be placed on the bottom surface (or other surface or side) of the device as desired by a user. Thus, the device stand can be utilized with a wide range of devices. The device stand may include an attachment or anchoring point to attach and secure the device stand to a device. The location of the attachment or anchoring point is illustrated in FIG. 3 at 302. The anchoring point may include attachment mechanisms, including, but not limited to, hook and loop fasteners, clips, adhesives (e.g., sticky tape, glue, putty, etc.), mechanical fasteners (e.g., bolts and nuts, rivets, pins and receivers, etc.), and/or the like.

For example, one type of attachment mechanism may include a male end of the device stand being inserted into a female fitting present on the device, or vice versa, in order to lock the device stand in place. As another example, another type of attachment mechanism may include small clips on the device that retract to allow the device stand to be fitted onto the device and then protract to hold the device stand onto the device. These are merely illustrative examples and are not intended to be limiting as any fastening or attachment technique may be utilized. In addition to the anchoring point or attachment point, the device stand may include additional connection points to hold the device stand onto the device. These may be located around the perimeter of the device stand and/or a location on the device to hold the device stand.

FIG. 3 illustrates the device stand in a landscape orientation. The landscape orientation will refer to the orientation where the two shorter parallel edges are at the top and bottom of the device. In other words, the orientation as illustrated in FIG. 3. The portrait orientation will refer to the orientation where the two longer parallel edges are at the top and bottom of the device. In other words, the orientation as illustrated in FIG. 4. These are the orientations referred to because this is the orientation of the device when utilizing a foldable device with the device stand. However, when utilized with other devices, the devices may not be in landscape orientation when the device stand is in landscape orientation and/or may not be in portrait orientation when the device stand is in portrait orientation. Thus, landscape orientation and portrait orientation will refer to the orientation of the device stand as previously described and not to the orientation of the device.

In the landscape orientation, the stand utilizes a single-leg stand 301, also referred to as a kickstand. The leg of the stand is created from the first set of parallel edges. As illustrated in FIG. 3, the first set of parallel edges is longer than the second set of parallel edges, resulting in a rectangular-shaped frame. However, it should be noted that different lengths of edges may be utilized. For example, both sets of parallel edges may be the same length, resulting in a square-shaped frame. As illustrated in FIG. 3, single-leg stand 301 is a portion of the overall device stand. One of the first set of parallel edges includes a first pivot point 303. The pivot point may be a hinge or other component that allows a portion of the edge to pivot with respect to another portion of the edge. The pivot component is not illustrated in the figures as it is covered with the overmolding. Rather, the location of the pivot point is illustrated. The hinge may be any type of applicable hinge, for example, a barrel hinge, butt hinges, pivot hinge, plano hinge, and/or the like. Other pivot points may include, but are not limited to, a kerf, a relief, use of a second flexible material, and/or the like. The pivot point may be made to allow for adjustment of the leg to different angles or positions. For ease of readability, the term hinge may be used here throughout, but this term is not intended to be limiting.

The portion of the first edge above the pivot point is part of the attachment point or anchoring point. The portion of the first edge below the pivot point is moveable outward with respect to the front side of the device stand. This portion that moves is referred to as a leg or single-leg in this landscape orientation. In other words, if the device stand were installed on a device, the leg is the portion of the first edge below the pivot point that moves away from the device. This leg moves outward to a position that holds the device in an upright or semi-upright position. In other words, the leg can be moved outward to a location desired by the user so as to hold the device in a position desired by the user. The pivot point 303 may permit the single-leg 301 of the device stand to move between a range of angles. A range of angles may support a variety of information handling devices dependent on the weight of the device, user preference of viewing of the device, and/or the like.

In the system, the pivot point 303 includes a friction system, tooth system, and/or the like, that allows for the adjustment of the leg to different angles while still ensuring that the leg does not inadvertently move or slip while under the weight of the device. For example, a range of the angles produced by the hinge 303 in combination with the single-leg portion 301 of the device may cover a 5-degree angle between the single-leg portion 301 and the information handling device to a 15-degree angle between the single-leg portion 301 and the information handling device. This range of angle values is intended to be non-limiting, and simply illustrates how the single-leg portion 301 and the pivot point 303 may work in combination in establishing a desired viewing angle of the information handling device in an upright position for the user.

When a user determines that support for the device is no longer desired, the single-leg portion 301 may recess back to be planar with the other portions of the device stand. In the event that the device is designed to have the device stand, the leg may recess back into indent 304 and become flush with the device or additional portions of the device stand. Indent 304 acts a housing for the single-leg portion 301 to help prevent damage to the device stand and to make the device more portable and usable while the device stand not in use. When the device stand is no longer supporting the information handling device, the multi-orientation device stand may act as a foot or base for the device to prevent the device from slipping on a surface. In other words, in this example, the device stand may replace traditional component feet that prevent device slippage.

FIG. 4 illustrates the device stand in a portrait orientation. In this example, the longer parallel edges of the device stand are located at the top and bottom of the device stand as compared with the shorter parallel edges of the device stand. The portrait orientation device stand includes dual-leg portions 405A and 405B and a crosspiece 401 to support an information handling device in an upright position. The crosspiece 401 is an entire edge of the device stand that is being protruded outward by the dual-leg portions 405A and 405B. Each of the dual-leg portions 405A and 405B include a pivot point 403A and 403B, which may be any of the pivot points or components as described above. Hinges will be references for ease of readability. The location of the pivot point 403A and 403B on each of the edges is located to be parallel to a location on the other of the edges. In other words, pivot points 403A and 403B are parallel to each other, thereby creating dual-leg portions 405A and 405B that are equal in length to each other.

As with the landscape orientation, the lower portion of the edge below the pivot point can move with respect to the rest of the device stand. However, with the portrait orientation, the crosspiece 401 also moves with the dual-leg portion 405A and 405B. The crosspiece 401 and the dual-leg portions 405A and 405B move outward with respect to a front side of the device stand. Thus, these hinges 403A and 403B allow the dual-leg portions 405A and 405B to protrude outwards with respect to the front side of the device stand. The hinges 403A and 403B work in conjunction with each other so that the angle created by dual-leg portion 405A and hinge 403A and the angle created by dual-leg portion 405B and hinge 403B will be the same angle. Additionally, crosspiece 401 assists with ensuring the angles produced remain constant across both portions of the dual-leg portions 405A and 405B. The angles supported by the hinges may be the same or different as compared to the angles described in the landscape orientation. For example, the angles supported by the hinges in the portrait orientation may be greater than the angles supported by the hinges in the landscape orientation.

For ease of reference, the anchor position or attachment point 402 of FIG. 4 is the same as the anchor position or attachment point 302 of FIG. 3. As with the landscape orientation, when a user is not using the device stand to support an information handling device in a portrait orientation, the device stand may recess back into indent 404. Indent 404 is the same indent 304 as illustrated in FIG. 3, except being a different view of the indent 404 and allows the device stand to recess into the device to create a planar surface between the device stand and device. Alternatively, as previously described, the device stand may be raised from the bottom surface of the device. The stand orientations present in the example figures provided are intended to be non-limiting. Rather, the multi-orientation device stand may be applied to an information handling device however a user prefers.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A device stand, comprising:
a first set of parallel edges, wherein one edge of the first set of parallel edges comprises a first pivot point, wherein a portion of the one of the first set of parallel edges below the first pivot point is moveable outward with respect to a front side of the device stand; and
a second set of parallel edges, wherein the second set of parallel edges are perpendicular to the first set of parallel edges and wherein the second edge of the first set of parallel edges connects a bottom of both edges of the second set of parallel edges; and
wherein each edge of the second set of parallel edges comprises a pivot point, wherein a lower portion below the pivot point of each of the edges of the second set of parallel edges is moveable outward with respect to the front side of the device stand.

2. The device stand of claim 1, wherein the first set of parallel edges corresponds to a landscape orientation of the device stand.

3. The device stand of claim 1, wherein the second set of parallel edges corresponds to a portrait orientation of the device stand.

4. The device stand of claim 1, wherein a pivot point of one of the edges of the second set of parallel edges is located at a point on the one of the edges to be parallel with a location of the pivot point on the other of the edges of the second set of parallel edges.

5. The device stand of claim 1, wherein each of the first pivot point and the pivot point of each of the edges of the second set of parallel edges comprise hinges.

6. The device stand of claim 5, wherein the hinges comprise barrel hinges.

7. The device stand of claim 1, wherein each of the first set of parallel edges and each of the second set of parallel edges are made of a rigid material.

8. The device stand of claim 7, wherein the rigid material comprises a material selected from the group consisting of aluminum and plastic.

9. The device stand of claim 7, wherein the rigid material is covered in an overmolding.

10. The device stand of claim 9, wherein the overmolding comprises silicon.

11. The device stand of claim 1, comprising an attachment point to attach the device stand to an information handling device, the attachment point being located above the first pivot point.

12. A system, comprising:
an information handling device;
a device stand, wherein a front side of the device stand is attachable to a back side of the information handling device, the device stand comprising:
a first set of parallel edges, wherein one edge of the first set of parallel edges comprises a first pivot point, wherein a portion of the one of the first set of parallel edges below the first pivot point is moveable outward with respect to the front side of the device stand; and
a second set of parallel edges, wherein the second set of parallel edges are perpendicular to the first set of parallel edges and wherein the second edge of the first set of parallel edges connects a bottom of both edges of the second set of parallel edges; and
wherein each edge of the second set of parallel edges comprises a pivot point, wherein a lower portion below the pivot point of each of the edges of the second set of parallel edges is moveable outward with respect to the front side of the device stand.

13. The system of claim 12, wherein the device stand, when attached to the back side of the information handling device, creates a planar surface with the back side of the information handling device.

14. The system of claim 12, wherein the first set of parallel edges corresponds to a landscape orientation of the system.

15. The system of claim 12, wherein the second set of parallel edges corresponds to a portrait orientation of the system.

16. The system of claim 12, wherein a pivot point of one of the edges of the second set of parallel edges is located at a point on the one of the edges to be parallel with a location of the pivot point on the other of the edges of the second set of parallel edges.

17. The system of claim 12, wherein each of the first pivot point and the pivot point of each of the edges of the second set of parallel edges comprise hinges.

18. The system of claim 12, wherein each of the first set of parallel edges and each of the second set of parallel edges are made of a rigid material.

19. The system of claim 12, comprising an attachment point to attach the system to an information handling device, the attachment point being located above the first pivot point.

20. A device stand, comprising:
a first set of parallel edges, wherein one edge of the first set of parallel edges comprises a first hinge, wherein a portion of the one of the first set of parallel edges below the first hinge is moveable outward with respect to a front side of the device stand, wherein the first set of parallel edges corresponds to a landscape orientation of the system; and
a second set of parallel edges, wherein the second set of parallel edges are perpendicular to the first set of parallel edges and wherein the second edge of the first set of parallel edges connects a bottom of both edges of the second set of parallel edges, wherein the second set of parallel edges corresponds to a portrait orientation of the system;
wherein each edge of the second set of parallel edges comprises a hinge, wherein a lower portion below the hinge of each of the edges of the second set of parallel edges is moveable outward with respect to the front side of the device stand;
wherein the device stand is attachable to an information handling device, wherein the front side of the device stand attaches to a back side of the information handling device; and
wherein each of the first set of parallel edges and each of the second set of parallel edges are made of a rigid material.
